(19) United States
(12) Patent Application Publication
(10) Pub. No.: US 2026/0295658 A1
(43) Pub. Date: Oct. 1, 2026

(54) MOLD BODY AND METHOD FOR MONITORING THE MOLD BODY

(71) Applicant: Cunova GmbH, 49074 Osnabrück (DE)

(72) Inventors: ALEXANDER BEEL, Bünde (DE); DIETMAR KOLBECK, Steinfeld (DE); HANS-GÜNTER WOBKER, Bramsche (DE)

(73) Assignee: Cunova GmbH, 49074 Osnabrück (DE)

(21) Appl. No.: 19/489,145

(22) PCT Filed: Jun. 3, 2024
(86) PCT No.: PCT/DE2024/100497

§ 371 Date: Dec. 1, 2025

(30) Foreign Application Priority Data
Jun. 9, 2023 (DE) 10 2023 115 158.4

(51) Int. Cl. B22D 2/00; B22D 11/16; H04W 4/38

(52) U.S. Cl. CPC B22D 2/00; B22D 11/166; H04W 4/38

(57) ABSTRACT

A mold body includes a mold plate with a casting side which can be reworked through material removal to incrementally change a thickness of the mold body, a sensor box including a base body inserted in an end face of the mold plate at a distance from the casting side of the mold plate, and a length sensor system arranged on a flange of the sensor box for measuring the thickness of the mold plate. The length sensor system includes several conductor tracks arranged at a distance to each other in a thickness direction. Material of the length sensor system is removed to incrementally decrease a number of the spaced-apart conductor tracks. Based on the number of existing conductor tracks, the sensor box determines a measured value, which correlates with the thickness of the mold body,

The invention relates to a mold body and a method for monitoring the mold body.

Mold bodies of continuous casting molds are subject to wear during use, which leads to changes in the surface of the casting side. The casting sides are reworked by the operator. Reworking is carried out by removing material. The process can be repeated several times. The usage data and the rework condition are ascertained for this purpose.

Casting process data, e.g., the operating time, are usually only linked manually with mold data, such as the plate thickness or the reworking condition. Process data on the reworking condition of the mold is normally recorded and documented manually.

For the state of the art, reference is made to DE 100 28 304A1 , which discloses a method for casting data processing of a continuous casting mold. It is proposed to arrange cooled fieldbus modules directly on the continuous casting mold and to feed data to a control system of the continuous casting plant via a bus line.

EP 3 831 510 A1 discloses that a sleeve can be arranged in a recess on a mold wall of a continuous casting plant, In which sleeve an RFID transponder is fixed by means of adhesive in order to implement usage tracking.

US 2013/0 333 473 A1 describes a real-time monitoring method for mold plates in which the data is transmitted wirelessly.

The invention is based on the object to propose a mold body and a method for monitoring it, whereby the casting process data can be ascertained more easily in order to enable better use thereof for reworking.

To attain this object, a mold body according to patent claim 1 and a method for monitoring the mold body according to patent claim 7 are proposed.

The mold body according to the invention includes at least one sensor box with the following features: The sensor box has a length sensor system for measuring a thickness of the mold body, wherein the length sensor system has several conductor tracks arranged at a distance to each other in a thickness direction of the mold body, wherein the sensor box determines a measured value based on the number of existing conductor tracks, which measured value correlates with the thickness of the mold body. Furthermore, the sensor box includes an NFC antenna, a battery as well as a control unit. The control unit includes a processor, a flash memory, a RAM memory, at least one further sensor as well as a second antenna. The NFC antenna is equipped for near-field communication. It serves to activate the sensor system of the sensor box via an external signal and to enable a subsequent data transfer for reading out the sensor box. The battery ensures power supply. The entire sensor system, in particular the components of the control unit, is preferably optimized to achieve a service life of more than 5 years without replacing the battery or the sensor box of the mold plate.

The flash memory is a digital memory module for non-volatile storage without maintenance energy consumption. It is also referred to as flash EEPROM. In particular, a unique identifier (ID of the mold body) is stored in the flash memory.

Furthermore, the control unit contains at least one further sensor. A sensor of the at least one further sensor is used to record the oscillation of the mold body. The control unit contains a second antenna. The second antenna is preferably a Bluetooth Low Energy (BLE) antenna. This standard is specifically conceived for sensors in order to transmit wireless data as energy-efficiently as possible. The data is read out without contact.

With the mold body according to the invention and the at least one sensor box arranged on it, casting process data can be ascertained, like for example the operating time and the oscillation as well as mold process data, e.g., the plate thickness. The sensor box automatically records the process data of the mold. The mold data also includes the maintenance history, which can be documented. By using several sensor boxes, i.e., by recording the oscillation at several locations of a mold, it is possible to detect wobbling movement of the mold body. Wobbling movements can cause increased wear on the mold as well as product defects or, in extreme cases, a strand break.

With regard to the reworking condition of the mold plate, it is considered particularly advantageous to connect the sensor box to a length sensor system for measuring a thickness of the mold body. The length sensor system includes several conductor tracks arranged at a distance to each other in a thickness direction. The conductor tracks have a fixed defined distance. The distance between the conductor tracks is, for example, 0.05 or 0.2 millimeters and defines a measurement increment. When showing signs of wear, the mold plates are reworked. During the process, the mold plate is milled. As a result of the positioning of the length sensor system or the individual conductor tracks, the number of conductor tracks is hereby reduced or individual conductor tracks are interrupted. The sensor box or the sensor system arranged therein determines the number of existing or intact conductor tracks over a measuring range, which, due to the incremental arrangement assumes a particular measured value, which in turn correlates with the thickness of the mold body. In this way, the reworking status of the mold plate can be recorded automatically.

The sensor box includes a housing and a cover so that the sensor system is protected. The sensor box is detachably connected to the mold body. In particular, the sensor box is screwed to the mold body. Accommodating the sensor system in a housing with a cover has the advantage that the sensor box can be removed during the reworking step. The sensor box is preferably made of plastic, in particular Teflon, in order to enable the sensor system to be read out using NFC and the second antenna.

The sensor box is preferably placed on the mold body in a highly protected position. In particular, the mold body is a mold plate that has a narrow end face into which the sensor box is inserted. The sensor box includes a base body which is arranged at a distance to a casting side of the mold plate. The base body includes, in particular, a flange that protrudes toward the casting side. At least part of the length sensor system for measuring the thickness of the mold plate is preferably arranged on this flange protruding toward the casting side. The sensor box is preferably attached to the upper region of an end face of a mold plate. The term “up” refers to the installation position, wherein “up” refers to the casting end of the mold.

Overheating of the sensor system is ruled out in this position. There is no contact between the base body and the liquid melt. Furthermore, the sensor system can be positioned here in such a way that the length sensor system has direct contact with the hot side/casting surface of the mold plate to be processed.

A method for monitoring the mold body is described in patent claim 7, according to which the at least one further sensor ascertains an oscillation of the mold body during casting, with the time of the oscillation being stored. When an acceleration, i.e., an oscillation, is detected, a measurement is executed over a few seconds, for example, over 5 to 15 seconds, in particular 10 seconds. Using a logic adapted to the continuous casting, the control unit is able to automatically ascertain the presence of a casting process.

The frequency range of the oscillation of the mold body is preferably between 1 Hz and 10 Hz. In addition, there must be a sinusoidal movement. The sinusoidal movement is detected by an FFT analysis.

When these conditions are met, the control unit records the start time of the acceleration event. A control measurement is automatically performed after a specified interval, for example after 5 to 30 minutes. This measurement is compared with the previous measurement. If the measurement has similar parameters, e.g., a similar frequency range, the operating time and the average frequency in Hz are recorded for this measurement period. The operating time and the oscillation are recorded as long as the oscillation or the acceleration event, i.e., the casting sequence, lasts. All data are preferably encrypted.

An interface can be used to identify the mold body and to establish a connection with the sensor system, which transmits the sensor data to a readout unit and from there to an evaluation unit. This may involve a mobile handheld device, in particular a smartphone. Modern smartphones have the necessary antennas and interfaces. The evaluation is carried out via an app on the smartphone or software provided specifically for this purpose on a mobile handheld device. The evaluation unit can transfer the data to a server-side database, which can be accessed by manufacturers and/or customers via specific interfaces. All sensor systems can be read out only via a digital key that can be verified on the smartphone or readout unit.

Before being installed in the mold body, it is essential that the sensor system is described with the mold body ID as a unique identifier. The app on the smartphone or readout unit then calculates the total time, i.e., the sum of all individual sequences of use of the mold body. The process data are displayed sequentially in the app. The read out data can be supplemented with photos and text generated directly on the smartphone, which is helpful for maintenance documentation. With the help of the app, the data gained in this way can be synchronized with a server-based database. In addition to the casting process data, the database can also store other information, such as customer information, master data, product name, material, material batch number, order date, production date, coating, taper, drawing number, and weight. In addition, documents such as measurement reports, drawings, etc. can be stored in the database. The database can also be accessed via a customer portal. In the customer portal, automated statistics regarding temperature load and operating times can be displayed, which statistics can be used to determine the performance of the mold plates.

In particular, the use of multiple sensor systems in a mold body enables determination of harmful wobbling movements of the mold body.

Initially, a mold body can be provided with a unique identifier, for example a QR code. The QR code can be read by a camera on the smartphone and correlates with the mold body ID stored in the sensor box. When these data are linked, the QR code becomes superfluous. All casting data and condition data of the mold can then be automatically assigned via the smartphone.

With the mold body according to the invention or the method according to the invention for monitoring the mold body, it is no longer necessary to manually link casting process data with mold data, in particular the plate thickness. Process data for the rework condition of the mold no longer need to be manually recorded and documented. The performance of the mold can be evaluated automatically. In addition, wobbling movements can be detected on the mold side in order to draw conclusions about increased wear on the mold.

An exemplified embodiment of the invention is explained in more detail hereinafter with reference to the drawings. It is shown in:

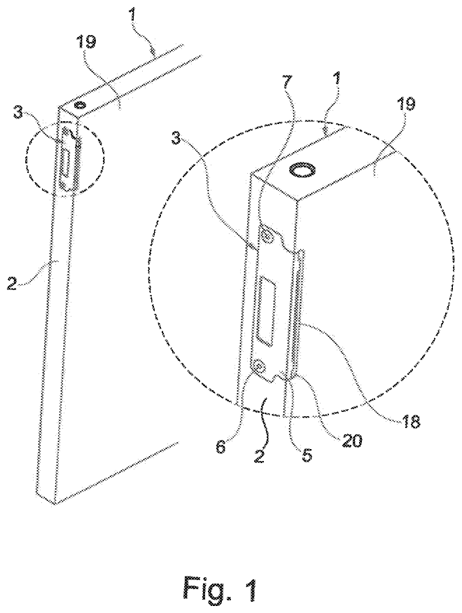

FIG. 1 a perspective view of a mold body with an enlarged detail in its upper corner area;

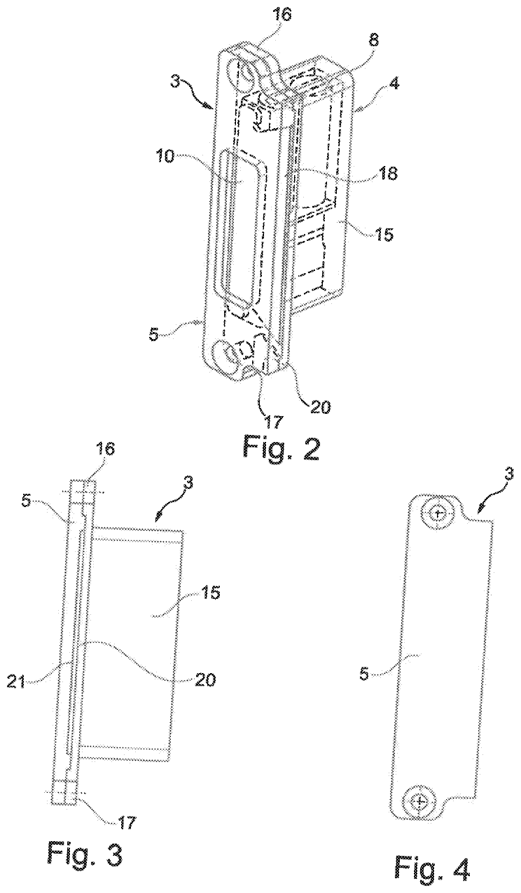

FIG. 2 a sensor box inserted into the mold body of FIG. 1;

FIG. 3 a first side view of the sensor box of FIG. 2;

FIG. 4 the sensor box of FIG. 2 in a view onto its cover; and

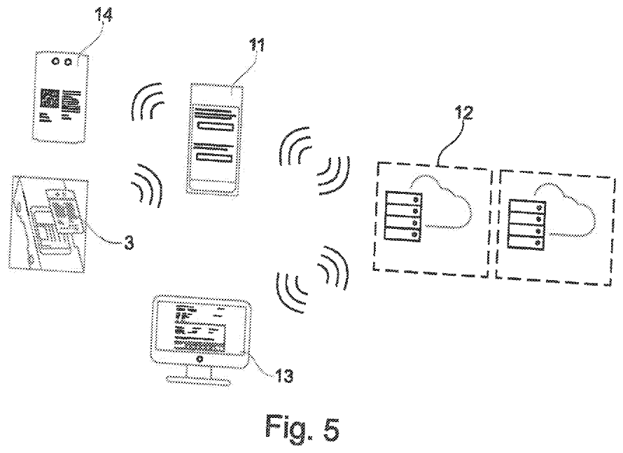

FIG. 5 the overall system for monitoring the mold body.

FIG. 1 shows a mold body 1 in the form of a mold plate with a view directed towards its casting side 19. In the upper corner region of the mold body 1, a sensor box 3 is located on an end face 2 and is shown slightly larger in the detailed view. FIG. 2 shows the sensor box 3 with further details. The sensor box 3 is roughly shaped like a mortise lock for a door, i.e., its housing 4 has a narrow, cuboid base body 15, on one end of which fastening tabs 16, 17 are arranged at opposite upper and lower ends and protrude beyond the cuboid base body 15. The sensor box 3 is inserted into the end face 2 and does not protrude beyond the end face 2 of the mold body 1. The sensor box 3 is located in the upper outer region of the illustrated mold plate or mold body 1 in order to preclude the sensor system from overheating sensor system. The sensor box includes a length sensor system 18 for measuring the thickness of the mold body 1.

The sensor box 3 includes a cover 5, each made of plastic, in particular Teflon. The base body 15 with the fastening tabs 16, 17 is arranged recessed in a depression in the end face 2. The cover 5, which can be screwed to the end face 2 and the fastening tabs 16, 17 using screws 6, 7, is flush with the end face 2. As a result, the sensor box 3 is protected from mechanical damage.

The sensor box 3 accommodates a battery 8 and a control unit 9. The control unit 9 has a processor, a flash memory, a RAM memory as well as one further sensor, which in this case is an acceleration sensor, and a second antenna. The second antenna involves a BLE antenna. The NFC antenna 10 is arranged on the front side of the sensor box 3, i.e., in the area of the cover 5. The NFC antenna 10 serves to activate the sensor system upon initial contact with a readout device, not shown in detail, and to initiate the data exchange.

The housing 4 of the sensor box 3 has adjacent to the cover 5 a flange 20 which extends in the installation position according to FIG. 1 to the casting side 19 of the mold body 1. The flange 20 is completely covered by the cover 5, so that the cover 5 is wider between the end-side fastening tabs 16, 17 than the base body 15. The flange 20 extends over the entire length of the base body 15, with the longitudinal direction, i.e., the length, referring to the casting direction in the installation position. A gap 21 is located between the cover 5 and the flange 20 (FIG. 3). The length sensor system 18 is arranged in the gap 21 (FIG. 2). In the installation position according to FIG. 1, the flange 20 and the cover 5 protrude up to the casting side 19 with the length sensor system 21 located in-between. When the casting side 19 is reworked, i.e., milled, material from the flange 20, material from the length sensor system 18, and also material from the cover 5 are removed at the border side. In the initial situation, the flange 20 and the cover 5 each end flush with the casting side 19 with their narrow edges together with the length sensor system 18 located in-between (FIG. 1). The cover 5 and the flange 20 hold the length sensor system 18 and support it, especially during material removal machining.

The length sensor system 18 includes conductor tracks which extend at a distance to each other at a number which decreases incrementally as material is removed. During reworking of the mold body 1, the thickness of the mold body 1 is incrementally changed. These incremental changes are ascertained by the length sensor system 18 and the sensor box 3 and allow conclusions to be drawn about the thickness of the mold body 1.

FIG. 5 shows an overall system for monitoring the mold body 1. A readout unit 11 in the form of a smartphone can read a QR code 14 using a camera and in addition is in wireless contact with the sensor box 3 on the mold body 1, evaluates the read-out data, and transmits it to a server architecture 12 for further processing. The server architecture 12 can be used to provide a customer portal 13 to make mold-specific data available to customers.

### REFERENCE SIGNS

1—mold body
2—end face
3—sensor box
4—housing
5—cover
6—screw
7—screw
8—battery
9—control unit
10—NFC antenna
11—readout unit
12—server architecture
13—customer portal
14—QR code
15—base body
16—fastening tabs
17—fastening tabs
18—length sensor system
19—casting side
20—flange
21—gap

1-10. (canceled)

11. A mold body, comprising:
a mold plate having an end face and defining a casting side which is capable of being reworked through material removal to incrementally change a thickness of the mold body;
a sensor box including a base body inserted in the end face at a distance from the casting side of the mold plate, an NFC antenna, a control unit and a battery, with the control unit including a processor, a flash memory, a RAM memory, at least one further sensor, and a second antenna, said sensor box including a flange projecting toward the casting side of the mold plate; and
a length sensor system arranged on the flange of the sensor box for measuring the thickness of the mold plate, said length sensor system including several conductor tracks arranged at a distance to each other in a thickness direction,
wherein material of the length sensor system is removed to incrementally decrease a number of the conductor tracks extending at a distance to each other, and
wherein the sensor box is designed to determine a measured value based on the number of existing conductor tracks, which measured value correlates with the thickness of the mold body.

12. The mold body of claim 11, wherein the second antenna is a Bluetooth Low Energy antenna.

13. The mold body of claim 11, wherein the sensor box includes a housing and a cover attachable to the housing.

14. The mold body of claim 13, wherein the housing is made of Teflon.

15. The mold body of claim 11, further comprising a plurality of said sensor box.

16. A method for monitoring the mold body of claim 11, the method comprising:
the at least one further sensor ascertaining an oscillation of the mold body during casting; and
storing a time of the oscillation.

17. The method of claim 16, further comprising:
activating the NFC antenna by a readout unit;
the NFC antenna activating the control unit;
establishing with the control unit a connection between the control unit and the readout unit via the second antenna; and
transferring data to the readout unit.

18. The method of claim 17, wherein a transfer of the data comprises a transfer of a mold body ID which is stored in the control unit, and further comprising:
verifying the mold body ID in an evaluation unit of the readout unit; and
after successful verification, clearing a further data transfer to the readout unit.

14. The method of claim 17, further comprising determining a wobbling movement of the mold body via readout acceleration data of a plurality of said sensor box of the mold body.
